(19) United States
(12) Patent Application Publication
(10) Pub. No.: US 2013/0203026 A1
(43) Pub. Date: Aug. 8, 2013

(54) System and Method for Virtual Training Environment

(71) Applicants: Ajith Sundaresh, Hiranandani Gardens (IN); Sudipto Mukherjee, Oshiwara (IN); Meghdoot Karnik, Manpada (IN); Debasree Majumdar, Kolkata (IN); Anindo Mitra, Mumbai (IN)

(72) Inventors: Ajith Sundaresh, Hiranandani Gardens (IN); Sudipto Mukherjee, Oshiwara (IN); Meghdoot Karnik, Manpada (IN); Debasree Majumdar, Kolkata (IN); Anindo Mitra, Mumbai (IN)

(73) Assignee: JPMorgan Chase Bank, NA

(21) Appl. No.: 13/371,879

(22) Filed: Feb. 13, 2012

(30) Foreign Application Priority Data
Feb. 8, 2012 (IN) 357/MUM/2012

(51) Int. Cl. G09B 19/00

(52) U.S. Cl. 434/219

(57) ABSTRACT

Embodiments of the invention are directed to a computer-implemented interactive virtual training system and method for facilitating the virtual interactive training of an employee over a network. The system may include computer storage components for storing training application program modules, a delivery engine for delivering a virtual interactive training environment, the environment including visual and audio components, computer processing components for accessing and executing the training application program modules, and a user input sensing mechanism for accepting and interpreting user input received in the virtual interactive training environment enabling the user to perform training tasks in the interactive virtual training environment. Each training application program module includes training material for one of multiple career paths, wherein the training material is divided into multiple levels, such that successful employee completion of an initial level for one career path allows access to a subsequent level for the career path.

### TECHNICAL FIELD

Embodiments of the invention are related to systems and methods for facilitating the virtual training of an employee by assessing, directing, and guiding the employee in his or her acquisition of functional and soft skills for a particular career path.

### BACKGROUND OF THE INVENTION

It is important for a business to develop and maintain a competent work force. To do so, a business must train its employees so that they can meet evolving business needs. New employees, particularly inexperienced employees, require a lot of training to develop basic skills.

Many businesses are also interested in the career progression of their employees. To maintain a steady progression of competent talent through a business' ranks, a business must inform employees about their possible career paths and help them develop the skills necessary to advance up the career ladder.

In response to these needs, businesses have developed computerized learning systems to help train and inform employees. Many of these systems are network or internet based, where a trainer posts training materials for the trainee's consumption. Such materials include audio/visual materials and/or text materials.

A typical computerized training system requires a trainee to logon to the system, which allows tracking of the resources the trainee consumes. The system tests a trainee's comprehension of a selected subject matter by using tests and/or quizzes at one or more stages in the presentation of the training material. The system keeps track of the trainee's progress and performance and reports the results to the trainer and/or the trainee.

A limitation of such systems is that an employee's evaluation relies on results from a quiz and/or test. Ascertaining whether a trainee developed competency for a given subject matter may not be effectively evaluated using such a technique. For example, a quiz can only discern a trainee's comprehension of teamwork and communication skills, not whether he effectively implements them.

Moreover, employees are becoming more and more technologically savvy. A typical presentation of learning materials followed by a quiz is not effective to maintain an employee's attention. Most employees, especially younger employees, are looking for a more immersive and interactive learning approach.

Accordingly, due to the above-mentioned deficiencies with currently existing computerized training systems, a solution is needed for creating a training system that engages an employee, facilitates interactive training for a given subject matter, and provides better means for evaluating the development of the employee's skills.

### SUMMARY OF THE INVENTION

In one aspect of the invention, a virtual interactive training system is provided for training a user for any one of multiple available career paths. The virtual interactive training system is accessible over a network and comprises a delivery engine for delivering a virtual interactive training environment, computer storage components for storing multiple application program modules, the application program modules including multiple virtual training applications, computer processing components for accessing and executing a selected virtual training application within the virtual interactive training environment, and a user interface mechanism for accepting user input. The system additionally comprises an interaction engine for analyzing user input and reporting feedback, and a customization engine for customizing the interactive training program's language and the user's avatar within the interactive training environment. The system also interfaces with a learning management system and a social network.

In one aspect of the invention, a computer-implemented virtual interactive training method is provided for training a user for any one of multiple available career paths, where the virtual interactive training method is executed over a network. The method includes storing multiple application program modules in computer storage components, the application program modules including multiple virtual training applications, receiving an employee selection of a selected virtual training application having a corresponding career path through a user interface mechanism, and implementing computer processing components for performing certain steps.

Those steps include accessing and executing the selected virtual training application for the corresponding career path. delivering content from the selected virtual training application to the user in a virtual interactive training environment via the network, processing user input to navigate through an initial level of the interactive training application, analyzing the user input to determine whether the user has successfully completed the level, delivering content for a subsequent level upon determination of successful completion of the initial level, and providing additional training materials from the stored application program modules when the user fails to successful complete an initial level. The method can also include interfacing with a learning management system and a social network and customizing the interactive training program's spoken language and the user's avatar within the interactive training environment.

In both the system and the method, application program modules include multiple virtual training applications, where each application includes training material for one of multiple career paths, wherein the training material is divided into multiple levels, such that successful employee completion of an initial level for one career path generates a subsequent level for the career path;

### BRIEF DESCRIPTION OF THE DRAWINGS

The present invention is described in detail below with reference to the attached drawings figures, wherein:

FIG. 1 is a block diagram illustrating an operating environment for a virtual training of an employee system in accordance with an embodiment of the invention;

FIG. 2 is a block diagram illustrating components of the interactive virtual training system and an exemplary process flow between the components in accordance with an embodiment of the invention;

FIG. 3 is a block diagram illustrating a user environment connected with an interactive virtual training system in accordance with an embodiment of the invention;

FIG. 4 is a block diagram illustrating exemplary virtual training applications in accordance with an embodiment of the invention;

FIG. 5 is a flow chart illustrating a customization method in accordance with an embodiment of the invention;

FIG. 6 is a flow chart illustrating a method for providing a virtual training environment and training program in accordance with an embodiment of the invention;

FIG. 7 is a flow chart illustrating a method for user interaction in accordance with an embodiment of the invention; and

FIGS. 8A-8G are renderings of an interactive virtual environment in accordance with embodiments of the invention.

### DETAILED DESCRIPTION OF PREFERRED EMBODIMENTS

Embodiments of the present invention are directed to a method and system for facilitating the virtual training of an employee. The system engages an employee, facilitates interactive training for a given subject matter, and evaluates the development of the employee's skills.

Embodiments of the invention relate to an interactive virtual training experience that can be utilized by users from a remote location. The interactive virtual training experience may be provided through any suitable visual and audio interactive equipment, such as for example, personal computers, laptops, smart phones, tablets, kiosks, or televisions.

The interactive experience may implement graphic imaging, audio sampling, or other technology to provide a interactive life-like training environment. An employee may use the virtual world to explore the different career paths available within an organization. In the system, each career path would have one or more levels, scenarios, story lines, or worlds for the employee to play. Each level would represent a position along the selected career path, and each level would have varying difficulties and different competency assessments.

An employee may be represented by a virtual avatar. The employee would navigate these levels by making decisions in response to virtual situations. For example, the employee's avatar may be placed on a virtual stock trading floor. The employee would then invest money in virtual assets and simulated market volatilities can help him learn what kind of positions to take in a given situation. Other examples include placing the employee's avatar in a virtual classroom, on a virtual ski slope, or in a virtual plane where the employee must make decisions to progress in the virtual world. Based on these decisions, the system could assess his competency skills, provide feedback, and direct him to any relevant training resources. An employee would not be able to start the next level until he passed the current level. In that way, an employee could not progress on the virtual career path until he had developed the skills necessary to succeed at the current level.

The system could implement an overarching story line that links the levels together. In a preferred embodiment, the story line has an employee using his avatar to go mountain climbing. Along the way he meets a good sorcerer who tells the employee that he must find the Lost City and defeat an evil sorcerer. The Lost City houses an elixir that will grant the evil sorcerer eternal life. To save the world, the employee must find the Lost City and elixir before the evil sorcerer does. To do so, the employee must set out on a journey, which consists of playing various levels that develop his real world skills. As the employee passes each level, he gains news powers to fight the evil sorcerer and comes closer to finding the Lost City.

The system could also interface with learning management systems or social networks to facilitate the training and assessment of the employee. If an employee fails to pass a level, the system could coordinate with the learning management system to provide the employee with other training resources, including class room training, reference materials, or educational games. Employees could form communities of learning and collaboration by using the system to interact with a social network.

The system is designed on an open architecture principle, which allows it to be scalable to different lines of business. For example, besides a stock trading training program, there could be other training programs, such as a mergers and acquisitions training program. Such a program would test and develop an employee's skills to evaluate merger deals and assess the value of potential acquisition targets. The system is adaptable to incorporate any virtual training program. Every employee at a business would have the opportunity to use the system to learn about other positions at the business and be able to hone the necessary skills.

The system also allows the games and the functional content to be interchanged if required. For example, a particular business unit within the firm may choose to have its employees play a skiing game to assess its employees on accounting concepts, but another business unit may choose to use the same skiing game to assess its employees on the basics of derivatives.

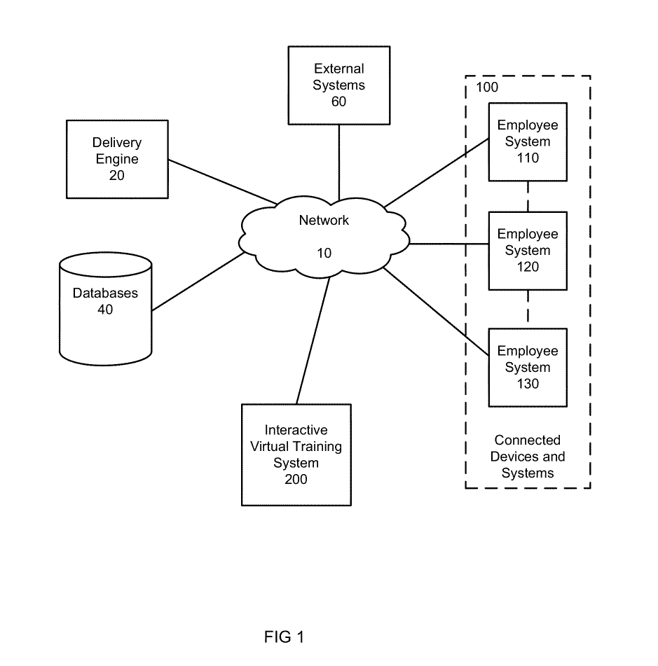

FIG. 1 is a block diagram illustrating an operating environment for an interactive virtual training system 200 in accordance with an embodiment of the invention. The interactive virtual training system 200 may be connected over a network 10 with multiple systems including a delivery engine 20, databases 40, and other external systems. Employee environments 100 may also be connected over the network and may include multiple employee systems 110, 120 . . . 130. Employees may additionally be referenced herein as “users”. In some cases, users may not be required to be employees, but may be individuals applying for a specific employment position. The system may be used to evaluate the individual's skills.

The network 10 may be the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths. Wireless data connections used in mobile computing may take a multiple forms. Cellular data service uses technologies including, such as, 3G networks and 4G networks. These networks are usually available within range of commercial cell towers. Wi-Fi connections may offer higher performance, but have limited range, Some enterprise deployments combine networks from multiple cellular networks or use a mix of cellular, Wi-Fi and satellite. Although one network is shown, a larger number of networks may be provided. All of the system components may communicate over a single network, such as the Internet, or over multiple networks, with the interactive virtual training system 200.

The interactive virtual training system 200 may be facilitated through a computer implemented application available over a network such as the Internet or alternatively through television service providers, such as Verizon and Comcast for providing a television application that would enable a user to perform any training from the user's television.

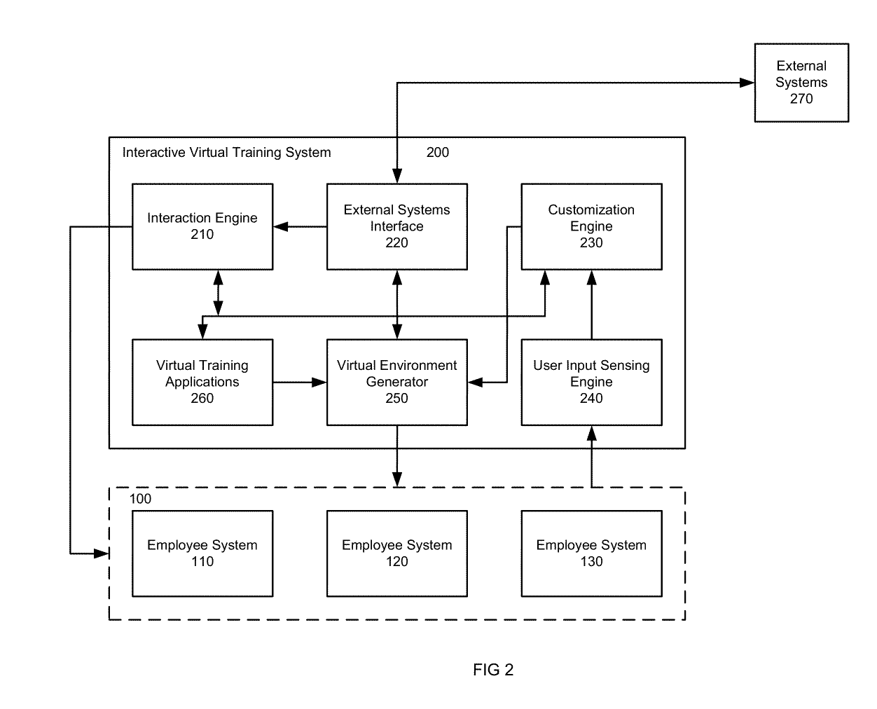

The interactive virtual training system 200 provides system users with a realistic interactive experience in real time. The details of the interactive virtual training system 200 are further described in connection with FIGS. 2-4.

The delivery engine 20 delivers virtual training environments for system users. As a user interacts with a training scenario through the interactive virtual training system 200, the delivery engine 20 delivers the changing virtual training environment. While the delivery engine is shown as a standalone component, it may alternatively be wholly integrated with the interactive virtual training system. In a preferred embodiment, the system uses Unity as the delivery engine and hosts it within the business's infrastructure.

Databases 40 may store information pertaining to the users in the system. The information may include, for example, the user's decisions made during a training scenario, the results of the user's competency assessment, or other information. In a preferred embodiment, user data is stored in an SQL server database.

Other external systems 60 may also communicate with the interactive virtual training system 200. Such systems may include social networking systems, learning management systems, or other systems. In a preferred embodiment, the system performs a “data pull” job to interact with the firm's learning system management system, using ODBC or Linked Servers or SSIS packages. All use similar methodology for pulling data. Through this interface, system administrators or privileged users are able to access user reports or upload data through the system's administration panel.

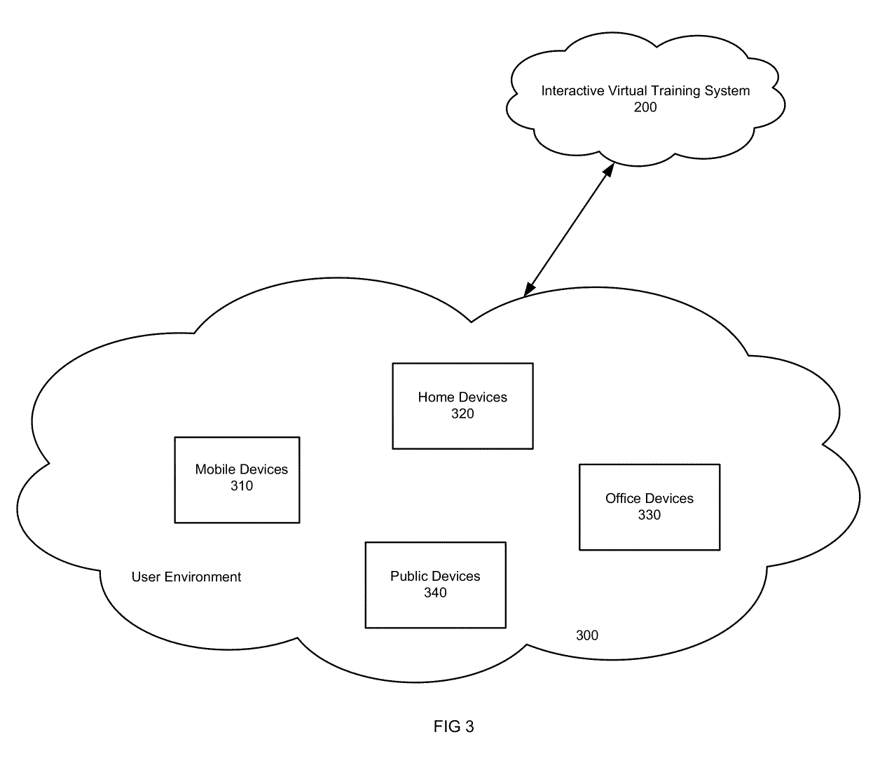

Employee systems 110, 120 . . . 130 preferably encompass a universe of each user's connected devices. An exemplary employee system 300 is illustrated and further described below in connection with FIG. 3. However, it should be understood that the type and number of connected devices may be virtually unlimited and may encompass both public and private devices to which the users do not have exclusive access.

FIG. 2 is a block diagram illustrating components of the interactive virtual training system 200 and an exemplary process flow between the components in accordance with an embodiment of the invention. The interactive virtual training system 200 may include, for example, an interaction engine 210, external systems interface 220, customization engine 230, virtual training applications 260, virtual environment generator 250, and user input sensing engine 240. It should be understood that although these components are shown as separate components communicating with one another, software components such as training applications 260 may be stored by a computer memory and accessed and executed by a computer processor in operation. While the computer processing components and computer memory are not shown separately, their functionality is integrated with the components shown and they are fully described herein.

External systems 270 may communicate with the interactive virtual training system 200 through the external systems interface 220. The interactive virtual training system 200 may also communicate with a user environment 100 including employee systems 110, 120, . . . 130.

The interaction engine 210 may include a software module executed by a computer processor in order to process user input and provide information to the user. Such information may include for example, analysis of a user's decision, timer information, notifications of other approaching deadlines, or any other feedback information. The interaction engine 210 may process input such as the choice to sell a virtual stock in order to notify the user of the effect on the user's virtual stock portfolio. The interaction engine 210 may further sense that a user does not know how to proceed in the training scenario and route that user to a virtual instructor within the interactive virtual training system 200. The virtual instructor may point the user to training materials, or explain how to navigate a screen, focus on certain fields of a document, troubleshoot a problem, or perform a task. The interaction engine 210 may receive information through the external systems interface 220 and transmit information through the virtual environment generator 250 or alternatively may transmit information outside of the virtual environment when appropriate. The interaction engine 210 may interface with a learning management system to direct an employee to relevant training sources.

The external systems interface 220 may accept input and send output to external systems that operate cooperatively with the interactive virtual training system 200. As set forth in respect to FIG. 1, the external systems may include delivery engine 20 for delivering the virtual training environment, the databases 40 for storing information, and any other systems capable of communication with the interactive virtual training system 200. A manager could access the databases 40 while the employee is participating in the training program and review the employee's performance data in the background.

The customization engine 230 may include software modules stored in computer memory and executed by a computer processor that allow system users to customize their virtual environments. For example, system users may select avatars to represent themselves within the environment. System users may select a particular region, country, or language in which the training experience can be conducted. The customization engine 230 may further store a sequence of introductory scenes to be displayed to the user prior to the selection of a particular virtual training application 260. The customization engine 230 may receive input from the user input sensing engine 240 and send output to the virtual environment generator 250.

The virtual training applications 260 may include various applications for presenting training scenarios. The virtual environment generator 250 or other computer processor may access these applications from the computer memory in order to manipulate the interactive virtual environment delivered by the delivery engine 20 in accordance with the training scenario requirements. The virtual environment generator 250 may operate in order to be compatible with a home computing device, handheld computing device, or public computing device. For a handheld device, the environment is typically miniaturized. However, if the device is capable, the system may offer the option of projecting the virtual environment from the handheld device onto a larger surface. Furthermore, the virtual environment may be generated for display on a large interactive screen.

The user input sensing engine 240 operates to process user input as he interacts with the training environment. The input may take various forms and preferably includes tactile or touch input and voice input. The input may also be keyboard input, mouse input, controller input, motion input, and for the purpose of security monitoring, may include retinal input or thumbprint input. The user input sensing engine 240 is operational to sense any input that may be provided from user interface tools on any devices connected within each user system. As used herein, the user input sensing mechanism 240 may include any hardware, software, or combination of hardware and software used by the processing machine that allows a user to interact with the computer processor or processing machine.

In embodiments of the invention, the virtual environment generator 250 may provide different virtual settings to allow interaction with the user. Part of the display may include information that the user can select via the input. The selection is detected by the user input sensing engine 240 and may prompt a response from an avatar within the system. The interactive experience also preferably provides both voice sensing and motion sensing capabilities. For example, when the user is standing in the floor of the stock exchange, he may make a signal with his hands to convey to another virtual stock trader what kind of position to take on a stock. Motion sensing technology would communicate with the interactive application to execute the desired instruction and update the virtual portfolio. In another example, the user's body language and tone of voice used when speaking to a virtual subordinate employee could be evaluated.

FIG. 3 is a block diagram illustrating an exemplary user environment 300 connected with the interactive virtual training system 200 in accordance with an embodiment of the invention. As illustrated, the user environment 300 may include mobile devices 310, home devices 320, office devices 330, and public devices 340. In a preferred embodiment, the user environment 300 has an internet browser to interface with the interactive virtual training system 200. Additional systems and devices may also be incorporated in the user environment.

Mobile devices 310 may include various known mobile computing devices, which also may be referenced as handheld devices, handheld computers or simply handhelds. These may be pocket-sized computing devices, typically having a display screen with touch input and/or a miniature keyboard. In the case of the personal digital assistant (PDA), the input and output are often combined into a touch-screen interface. The mobile devices 310 may also be or include iPhones, iPads, smart phones, laptops, netbooks, e-readers, tablet computers, or other devices. Typically these devices are also equipped with cameras or other imaging devices.

Home devices 320 and office devices 330 may include any standard computing equipment implemented in homes and offices. Additionally, users may implement more sophisticated computing equipment to obtain the full benefit of the interactive virtual training experience offered through the system. For example, users may implement large touch screens, motion sensing equipment, voice recognition units (VRUs), or other technologies.

Public devices 340 may include any publicly available computing devices, such as computers at an internet café or public library, or large touch screens available, for example, in hotel lobbies and train stations. In a preferred embodiments of the invention, users will be able to customize to enable different modes for public computing equipment and private computing equipment.

The interactive virtual training system 200 can implement computer hardware and software specifically designed for the delivery of cloud services, including multi-core processors, cloud-specific operating systems and combined offerings. Cloud computing provides computation, software, data access, and storage services that do not require end-user knowledge of the physical location and configuration of the system that delivers the services.

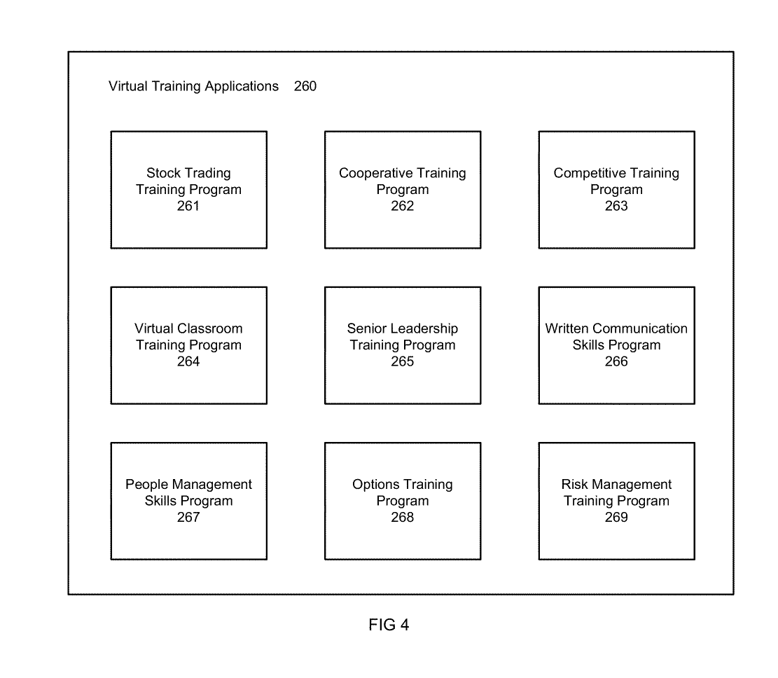

FIG. 4 is a block diagram illustrating illustrative virtual training applications 260 in accordance with an embodiment of the invention. The virtual training applications may include for example a stock trading training program 261, a cooperative training program 262, a competitive training program 263, a virtual classroom training program 264, a senior leadership training program 265, a written communication skills program 266, a people management skills program 267, an options training program 268, a risk management training program 269, or any other training program. All of these application programs may leverage existing applications that are used for example, in standard online application processing. They may include modifications or interface with plug-ins that adapt them for use with the interactive virtual environment.

The stock trading training program 261 may provide information to the virtual environment generator 250 including a program or programs executed to perform the appropriate steps for simulating the trading of stocks. Through the virtual environment generator 250, an avatar may be displayed to represent other stock brokers to interact with the user or the user's avatar. The stock trading training program 261 enables the system to perform the virtual buying and selling of stocks based on the decisions of the user. The user may issue commands to a stock broker avatar by voice, keyboard input, or by gestures. Visual representation of a stock exchange floor could be provided for visual enhancement. Sounds, like the chattering of a large crowd, could be provided to add distraction or sounds, like the ringing of a bell, could be used to encourage a user when he has made a good decision.

The cooperative training program 262 and the competitive training program 263 may provide information to the virtual environment generator 250 including a program or programs executed to allow a plurality of users to operate in the same virtual environment. The users would be able to interact with each other's avatars. In the cooperative training program 262, the users would work together on a task or a series of tasks, then they would be evaluated on the effectiveness of their teamwork. In the competitive training program 263, users would be pitted against one another to complete a task or a series of tasks, then they would be evaluated to see who worked the most efficiently and effectively. Such a program may include a point scoring system.

The virtual training program 264 may provide information to the virtual environment generator 250 including a program or programs executed to create a virtual classroom where one or more users' avatars can congregate. The avatar of a trainer can conduct the class. The trainer could be another user or a computer.

The senior leadership program training 265 may provide information to the virtual environment generator 250 including a program or programs executed to place a user's avatar in a virtual environment where he must make decisions on incomplete data, ambiguous situations, and unforeseen future situations.

The written communication skills program 266 may provide information to the virtual environment generator 250 including a program or programs executed to place a user's avatar in a virtual environment where he must draft an email and submit it. A reviewer could then use an avatar to review the email in the virtual environment, or the email could be routed through the interface with the firm's learning management system to allow a reviewer to evaluate the email outside the virtual environment.

The people management skills program 267 may provide information to the virtual environment generator 250 including a program or programs executed to place a user's avatar in a virtual environment where he must confront a particular behavioral situation with a subordinate employee represented by a virtual avatar. The user could choose from multiple responses that result in further repercussions that could be made known to the player. The program could also evaluate the user's body language or tone of voice and provide feedback.

The options training program 268 may provide information to the virtual environment generator 250 including a program or programs executed to place a user's avatar in a flight simulator. As the user is flying a plane, option pay-off diagrams could be presented and the user must make a selection. A correct selection causes the plane to move ahead faster, while a wrong choice causes the plane to dive. If the user chooses enough incorrect answers, the plane crashes.

The risk management training program 269 may provide information to the virtual environment generator 250 including a program or programs executed to place a user's avatar in a virtual environment where random numbers are used to generate market scenarios and risk positions. The environment simulates market reactions as the user takes a given risk position.

Generally, the training application programs may allow users to progress through multiple levels or tiers upon successful completion of each preceding tier. Each tier or level may provide a new virtual environment or simply slight modifications to a previously implemented virtual environment. If a user would not successfully complete a level, the training program may provide training resources for the user to review and allow the user to play the level again. A new level would not be available for the user to play until he successfully completes the current level.

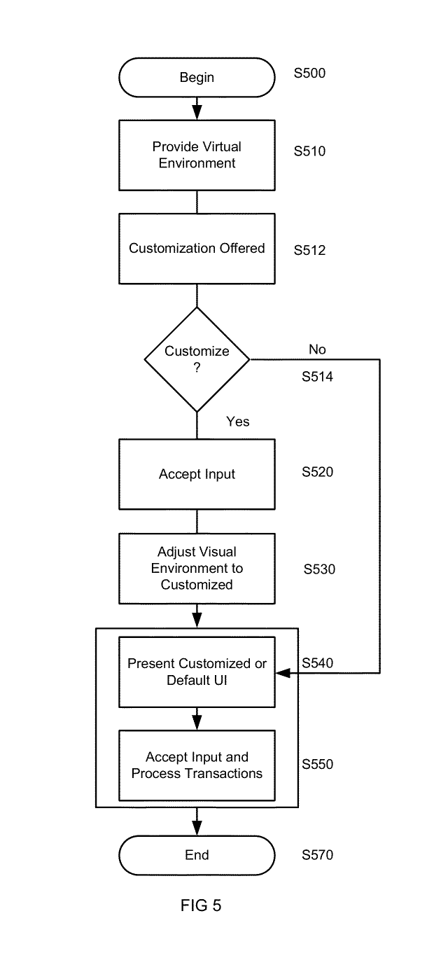

FIG. 5 is a flow chart illustrating a customization method in accordance with an embodiment of the invention. The method begins in S500 and the system provides an interactive virtual environment in S510. In S512, the system may offer customization options through the interactive virtual environment. The customization options may alter subsequent images presented in the interactive virtual environment. For example, the customization options may allow the user to pick an avatar to represent his or herself and further to pick a home training environment. The user may additionally be offered choice of language for interacting with other avatars, such as stock brokers within the interactive stock trading training environment or the subordinate employee in the people management skills program. If the user chooses to customize in S514, the system provides a user interface accepting the input in S520 and adjusts the interactive virtual environment to arrive at the customized environment in S530. If in S514, the user does not choose to customize, the system reverts to a default virtual environment. Typically, the default virtual environment will include a user's home training environment as determined based on stored data. If an avatar is used to represent the user, the avatar may be selected appropriate to the user's age and gender as determined based on stored data.

In operation, when the user further interacts with the system, either a selected customized interface or the default interface will be presented in S540. In S550, the user will accept input and process transactions while maintaining the selected virtual environment through the entire process until the process ends in S570. While FIG. 5 proposes one customization process, it should be recognized that other customization processes can be used.

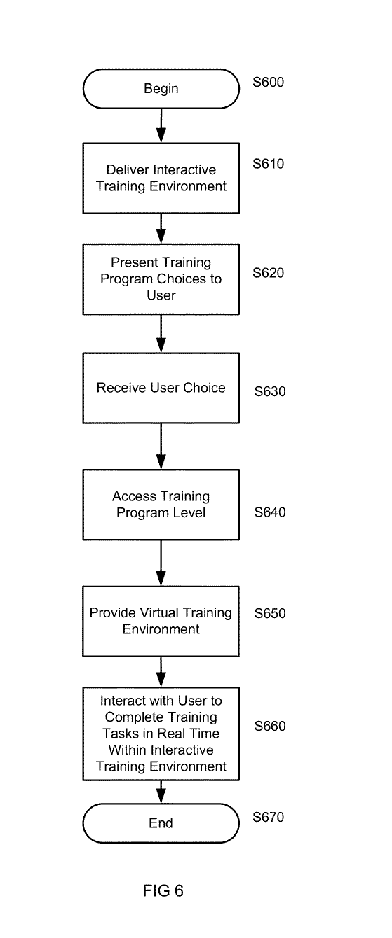

FIG. 6 is a flow chart illustrating a method for providing virtual training in accordance with an embodiment of the invention. The method begins in S600 and the delivery engine delivers the interactive training environment in S610. In S610, the interactive virtual environment presents choices to the user. For example, the interactive virtual environment may provide options for stock trading training, cooperative training, competitive training, classroom training, senior leadership program training, written communication skills program, people management skills program, options training program, or risk management training program. This also includes the unlocked levels for each training program. The rendering is optimally touch sensitive and responds to voice commands. In S620, the system receives a user choice and S630, the system retrieves the appropriate training program and appropriate training level for interacting with the user. In S640, the user accesses the selected training program level. In S650, the system provides the interactive virtual training environment and in S660, the system interacts with the user to complete training tasks in real time within the interactive virtual environment by executing the appropriate application within the customized or default virtual environment. The method ends in S670.

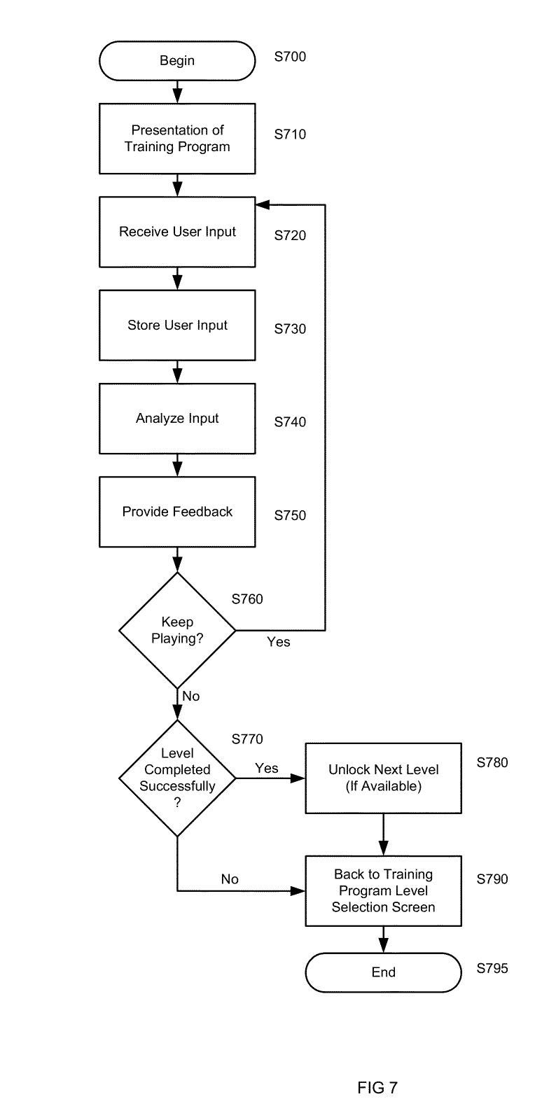

FIG. 7 is a flow chart illustrating a method for employee interaction in accordance with an embodiment of the invention. The method begins in S700 and in S710, the system displays a virtual interactive environment where a training program is presented to the user. In S720, the system receives the user's reaction to the training program via voice, touch, movement or other type of input. In S730, the system stores the user input. In S740, the system analyzes the user's input, where analyzing includes evaluating the user's response and determining if the user is acting independently or collaborating/competing with other users. In S750, the system provides feedback by reporting assessment scores and directing the user to training resources. In S760, the system determines if the user is still playing the level. If so, it loops back to S720 to receive more user input. If not, the system determines if the level was completed successfully. If so, the system unlocks the next available level for the virtual career path in S780. Regardless, in S790, the system takes the user back to the training program level selection screen. The method ends in S795.

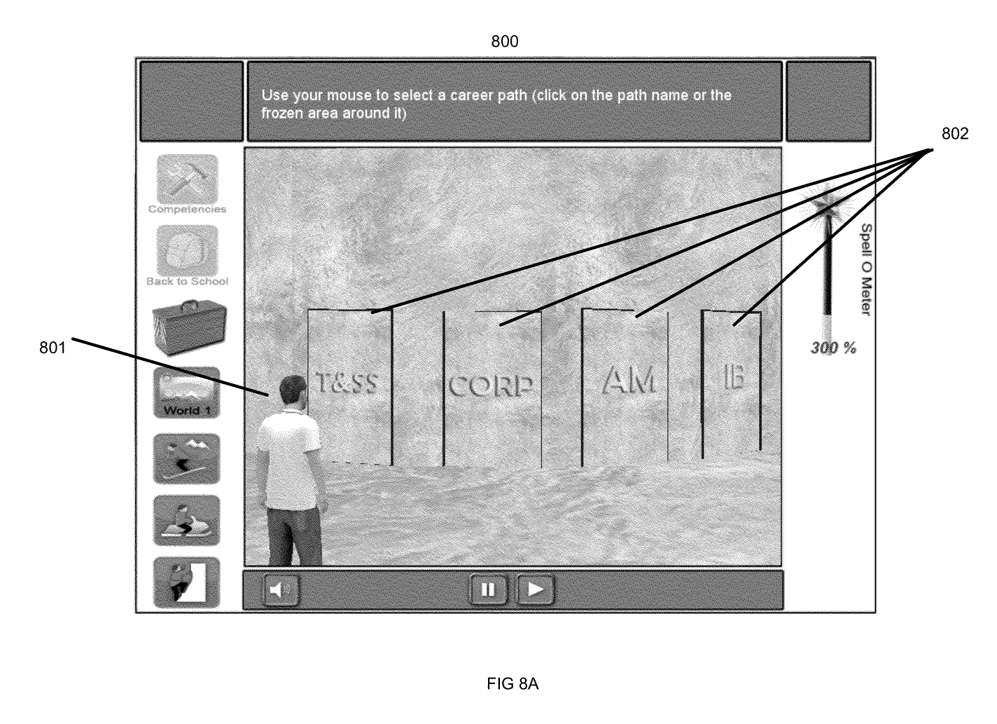

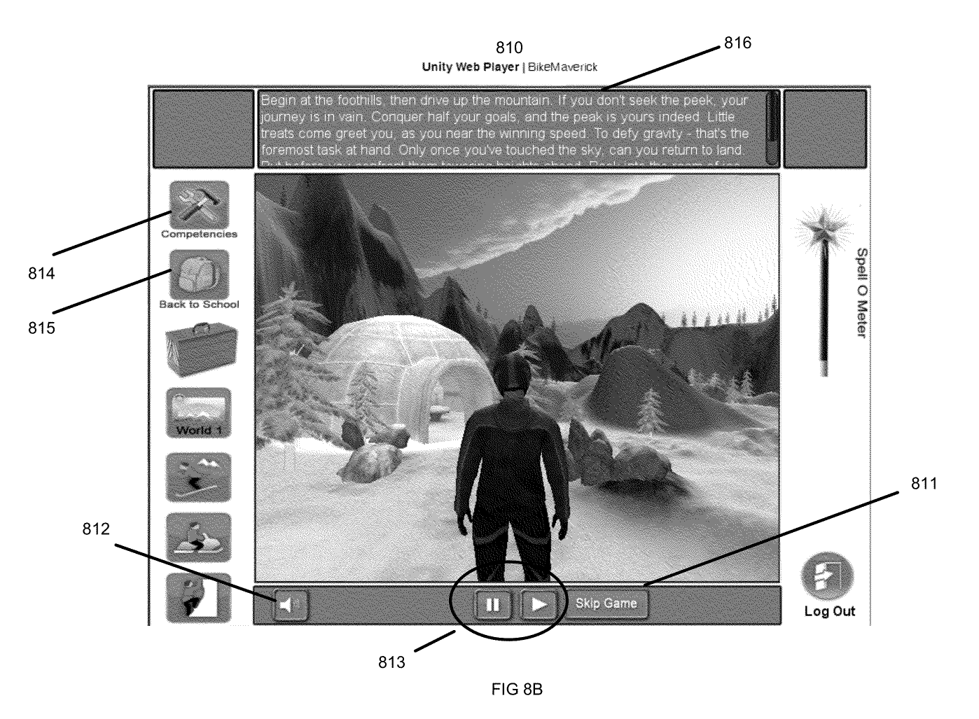

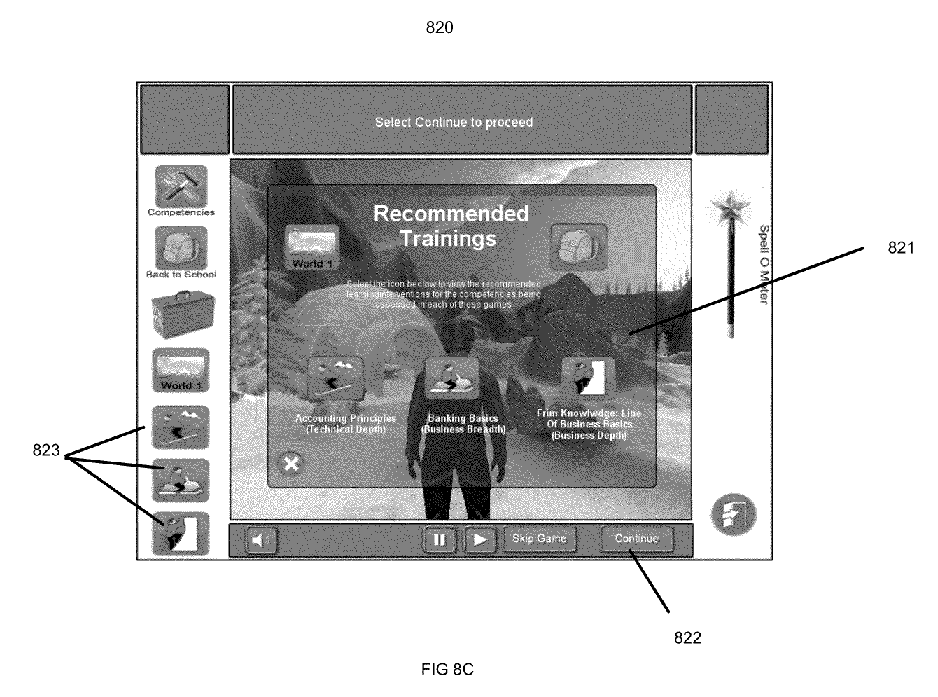

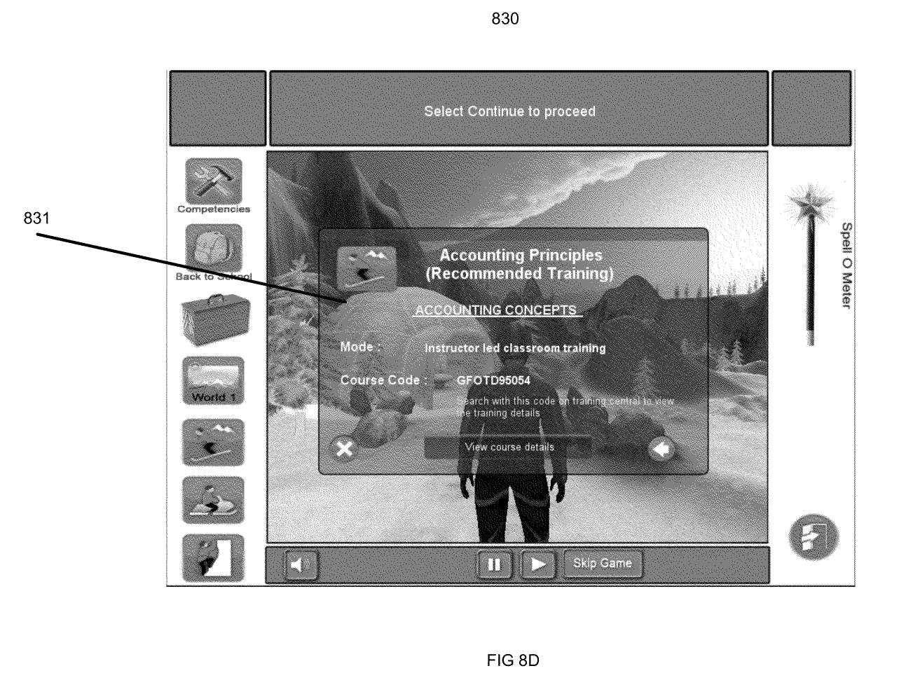

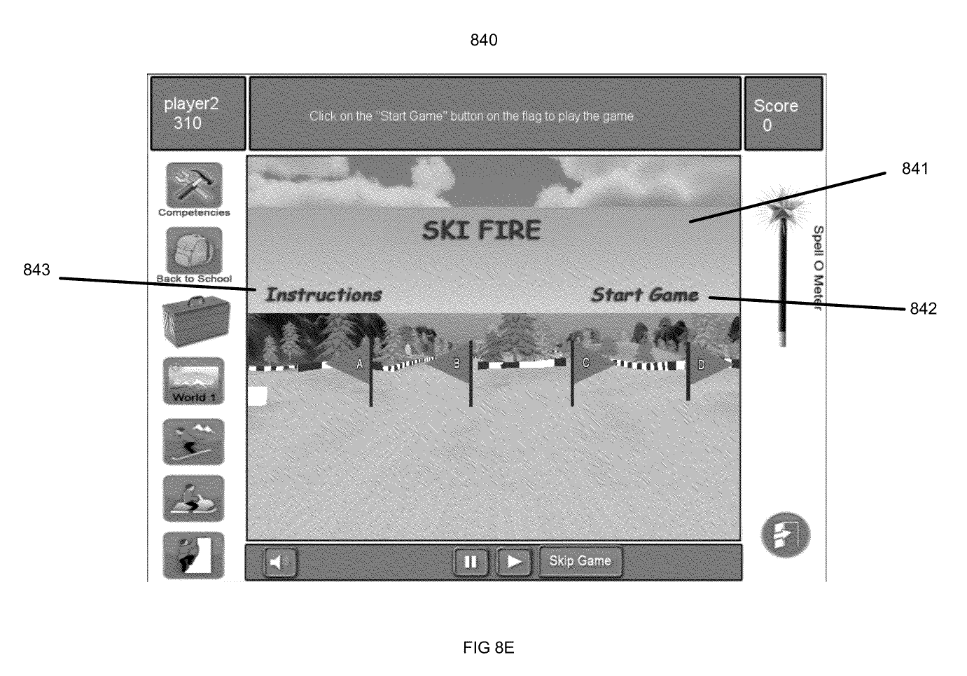

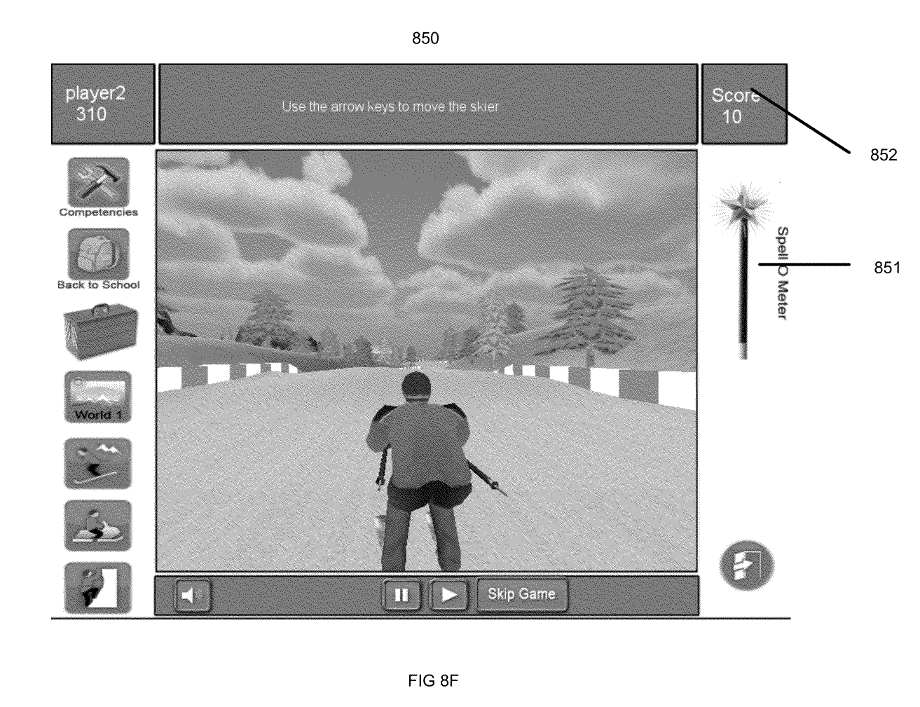

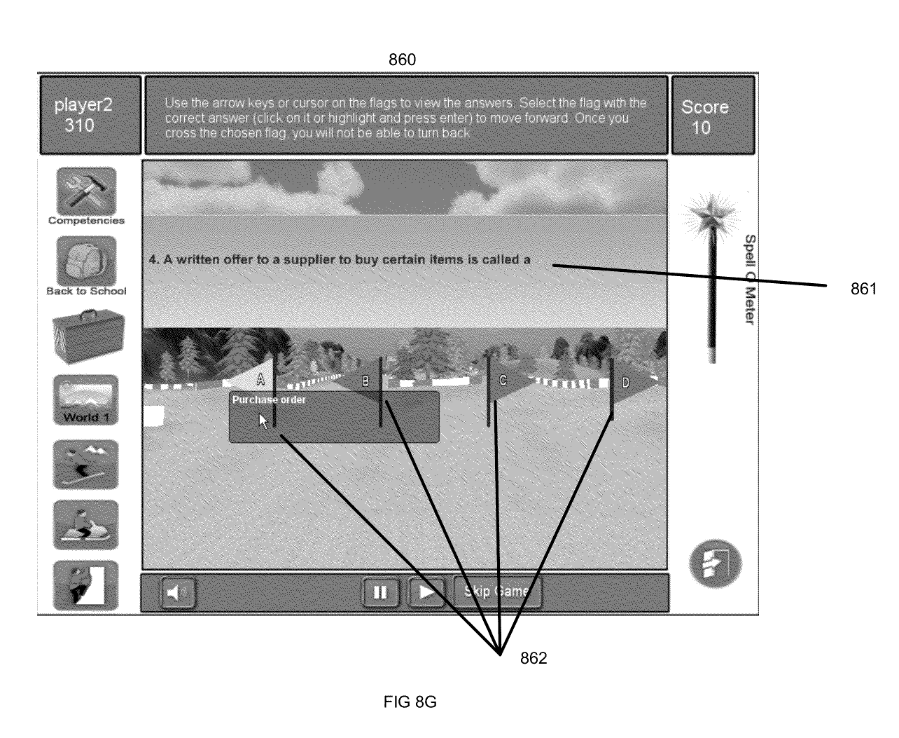

FIGS. 8A-8G are renderings of an interactive virtual training environment in accordance with embodiments of the invention.

FIG. 8A illustrates an interactive training environment 800, which, in embodiments of the invention, is delivered to the user's computer. An employee is represented by a virtual avatar 801 in a virtual environment (“School”). The user then selects a career path 802 by selecting information on the screen, such as the career path names or the “frozen area” around the names. The user may do this by using a keyboard, mouse, his voice, his body movement, or by other input.

FIG. 8B illustrates an interactive virtual environment 810 that includes a training program for a user. The top window 816 displays the story line for the level. The user may advance through the level by selecting information on the screen. The control buttons 813 allow the user to control the pace and flow of the messages 816 at the top of the screen. This allows the user to review instructions or information, or skip them altogether. A selectable button 811 allows the employee to skip the game, but only if he has already beaten it and is allowed to play the next level. The sound button 812 allows the user to adjust the sound on the game, which includes avatar speech and environmental sounds. A selectable button 815 allows the user to go “Back to School” and review training materials. A selectable button 814 allows the user view the “Competencies” needed to play and pass the level.

FIG. 8C illustrates an interactive virtual environment 820 that includes a training program for a user. After the user selects the selectable “Competencies” button 815, as shown in FIG. 8B, an informational window 821 pops open that describes the different competencies, or levels, that the user may choose to play. The user may go on to choose one by selecting continue button 822. Or, the user may directly choose a level by selecting one of the level buttons 823 on the side of the screen.

FIG. 8D illustrates an interactive training environment 830, which shows what happens when a user selects a level. In this case, the information window 831 describes the type of competency tested and the type of training mode.

FIG. 8E illustrates an interactive training environment 840, where the user may choose to start the selected level. In this case, the level is a skiing simulation. The informational window 841 contains the name of the level and the “Start Game” button 842 and the “Instructions” button 843. The user selects the “Start Game” button to initiate game play.

FIG. 8F illustrates an interactive training environment 850 where the user is playing the skiing level. A score board 852 displays how many points the user has accumulated during the current level. A “Spell O Meter” 851 displays how many special bonuses the employee has accumulated while playing. If the “Spell O Meter” is full, the employee can skip a training question, receive free in-game advice, or any other type of benefit.

FIG. 8G illustrates an interactive training environment 860 where the user is playing the skiing level and must answer a competency question. Information window 861 displays the question and the user must select one of the selectable flags 862 to answer. If the user answers correctly, his score increases.

The system of the invention or portions of the system of the invention may be in the form of a “processing machine,” i.e. a tangibly embodied machine, such as a general purpose computer or a special purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example. As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Apple OS X™ operating system, the Apache operating system, an OpenStep™ operating system, the Android™ operating system, the Apple iOS™ operating system, or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, camera, motion detector, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A virtual interactive training system for training a user for any one of multiple available career paths, the virtual interactive training system accessible over a network and comprising:
a delivery engine adapted to deliver a virtual interactive training environment via the network;
computer storage components for storing multiple application program modules, the application program modules including multiple virtual training applications, each application including training material for one of multiple career paths, wherein the training material is divided into multiple levels, such that successful employee completion of an initial level for one career path generates a subsequent level for the career path;
computer processing components for accessing and executing a selected virtual training application within the virtual interactive training environment;
a user interface mechanism for accepting user input received for selecting the virtual training application and within the virtual training application in the interactive training environment and forwarding the user input to the computer processing components for processing as input to the selected virtual training application.

2. The system of claim 1, wherein said network is a local area network, a wide area network, the internet, and combinations thereof.

3. The system of claim 2, wherein said virtual interactive training environment comprises text, video, audio, graphics, animation, and combinations thereof to simulate an interactive life-like environment.

4. The system of claim 3, wherein the virtual training applications include stock trading training applications, cooperative training applications, competitive training applications, senior leadership training applications, virtual classroom training applications, written communication skills applications, people management skills applications, options training applications, and risk management training applications.

5. The system of claim 4, wherein more than one user interacts with the virtual training application within the virtual interactive training environment.

6. The system of claim 4, wherein the computer processing components interface with a learning management system and a social network.

7. The system of claim 4, wherein said computer processing components includes an interaction engine for analyzing user input.

8. The system of claim 7, wherein said interaction engine reports said analyzed user input data.

9. The system of claim 8, wherein said user interface mechanism accepts tactile input and voice input.

10. The system of claim 9, wherein said user interface mechanism senses the body movement of the user within the virtual interactive training environment.

11. The system of claim 10, further comprising a customization engine for enabling a user to customize at least a spoken language within the virtual interactive training environment.

12. The system of claim 11, wherein said customization engine enables customization of a user avatar within the virtual interactive training environment.

13. A computer-implemented virtual interactive training method for training a user for any one of multiple available career paths, the virtual interactive training method executed over a network and comprising:
storing multiple application program modules in computer storage components, the application program modules including multiple virtual training applications, each application including training material for one of multiple career paths, wherein the training material is divided into multiple levels, such that successful employee completion of an initial level for one career path generates a subsequent level for the career path;
receiving an employee selection of a selected virtual training application having a corresponding career path through a user interface mechanism;
implementing computer processing components for performing steps including,
accessing and executing the selected virtual training application for the corresponding career path;
delivering content from the selected virtual training application to the user in a virtual interactive training environment via the network;
processing user input to navigate through an initial level of the interactive training application;
analyzing the user input to determine whether the user has successfully completed the level;
delivering content for a subsequent level upon determination of successful completion of the initial level; and
providing additional training materials from the stored application program modules when the user fails to successful complete an initial level.

14. The method of claim 13, wherein said network is a local area network, a wide area network, the internet, and combinations thereof.

15. The method of claim 14, wherein said virtual interactive training environment comprises text, video, audio, graphics, animation, and combinations thereof to simulate an interactive life-like environment.

16. The method of claim 15, wherein the virtual training applications include stock trading training applications, cooperative training applications, competitive training applications, senior leadership training applications, virtual classroom training applications, written communication skills applications, people management skills applications, options training applications, and risk management training applications.

17. The method of claim 16, further comprising interfacing with a learning management system and a social network.

18. The method of claim 17, wherein analyzing user input includes reporting assessment scores and directing said user to training resources that address any identified skill deficiency.

19. The method of claim 18, further comprising providing customization components for customizing for enabling the user to customize at least a spoken language within the virtual interactive training environment.

20. The method of claim 19, wherein the customization components enable customization of a user avatar within the virtual interactive training environment.
